(19) United States
(12) Patent Application Publication
(10) Pub. No.: US 2018/0351868 A1
(43) Pub. Date: Dec. 6, 2018

(54) MULTICAST ABR FLOW PRIORITIZATION USING ERROR DETECTION THRESHOLDS IN THE RECEIVER

(71) Applicant: Cisco Technology, Inc., San Jose, CA (US)

(72) Inventors: Charles T. CARTWRIGHT, Southampton (GB); Thomas P. BURNLEY, Winchester (GB); Gareth BOWEN, Chandlers Ford (GB); Robert A. DRISKO, Concord, MA (US)

(21) Appl. No.: 15/663,508

(22) Filed: Jul. 28, 2017

Related U.S. Application Data
(60) Provisional application No. 62/513,313, filed on May 31, 2017.

(51) Int. Cl. H04L 12/803; H04N 21/231; H04N 21/24; H04L 12/851; H04N 21/6377; H04L 12/927; H04L 29/06

(52) U.S. Cl. CPC H04L 47/125; H04N 21/23106; H04N 21/2405; H04N 21/8456; H04N 21/6377; H04L 47/805; H04L 69/165; H04L 47/2441

(57) ABSTRACT

Techniques for managing receiving, at a network receiver device, from a video streaming solution, segments for each of a plurality of video streams over one or more multicast channels, where the network receiver device is configured to cache the segments for consumption by one or more client devices. A first network congestion condition is satisfied at the network receiver device. In response to detecting the first network congestion condition is satisfied, a first one of the plurality of video streams having a lower priority is selected, relative to a second one of the plurality of video streams. Segments for the first video stream are requested using an alternate channel. Embodiments unsubscribe from a first one of the multicast channels for the selected first video stream.

### TECHNICAL FIELD

Embodiments presented in this disclosure generally relate to streaming content, and more specifically, embodiments disclosed herein relate to techniques for optimizing ABR streams within a network.

### BACKGROUND

As video transmission systems have matured, digital video is more readily available via a variety of different communications systems and networks. Specifically, digital video, such as television programs, can be transmitted as multicast digital bit streams of video signals to users over networks. Multicast digital bit streams typically include digital video frames. A predetermined number of frames is conventionally referred to as a Group of Pictures (GOP). The GOP lengths are typically 15 or 30 frames. With more advanced video formats, the GOP length can be substantially longer to reduce the bit rate.

To reduce costs and simplify the amount of effort associated with video transmission, different video compression/de-compression techniques have been developed and established. Some of the better known and more widely adopted video compression/de-compression standards include Motion Picture Experts Group 2 (MPEG-2) data streams and Motion Picture Experts Group 4 (MPEG-4) data streams. Conventionally, for purposes of video compression/decompression, a video stream is processed one frame at a time.

Compressed video transmission streams typically include a variety of different compression frame types. With MPEG-2 and MPEG-4, the bit streams generally include three different types of frames including Intra-frames, Predictive frames, and Bidirectional interpolated frames. In a typical decoding process, Intra-frames (I-frames) can be decoded independently without the need of referencing another frame. Thus, GOPs typically start with an I-frame. Predictive frames (P-frames) can be decoded by referencing a previous I-frame or P-frame. Bidirectional interpolated frames (B-frames) can be predicted from a previous and a following P-frame or I-frame. For a given video stream, all three ways of coding are attempted and the best and most efficient combination is utilized. For example, a common MPEG-2 video stream can be 15 frames long and have the sequence IBBPBBPBBPBBPBB.

Typically, a video stream, such as a MPEG-2 data stream, is transmitted from a multicast source to a router and/or switch via a network, e.g., an Internet Protocol (IP) distribution network. And upon receipt of the video stream, the router then transmits the video stream to a user device, such as a set-top box. Such a router (e.g., the user's Internet gateway) can potentially receive multiple multicast video streams at one time (e.g., one or more streams for each of a plurality of broadcast channels), and client devices (e.g., dedicated streaming devices such as the set-top box, mobile devices, tablet devices, etc.) can request specific streams to be output for display.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a system for delivering encoded video streams to client devices configured with an Adaptive Bitrate (ABR) profile selection component, according to one embodiment described herein.

FIG. 2 illustrates a network topology for delivering encoded video streams to client devices, according to one embodiment described herein.

FIG. 3 illustrates a network topology for delivering encoded video streams to client devices, according to one embodiment described herein.

FIG. 4 illustrates a workflow for providing encoded ABR video content for a plurality of broadcast channels, according to one embodiment described herein.

FIG. 5 illustrates a network environment configured with a video streaming management component, according to one embodiment described herein.

FIG. 6 illustrates a network environment that includes a network receiver device configured with a video streaming management component, according to one embodiment described herein.

FIG. 7 is a flow diagram illustrating a method for managing retrieval of video streams, according to one embodiment described herein.

FIG. 8 illustrates a method of managing ABR streams based on client-specified indications of priority, according to one embodiment described herein.

FIG. 9 is a flow diagram illustrating a method of managing ABR streams at a network receiver device, according to one embodiment described herein.

FIG. 10 is a block diagram illustrating a network device configured with a video streaming management component, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DESCRIPTION OF EXAMPLE EMBODIMENTS

### Overview

One embodiment presented in this disclosure provides a method that includes receiving, at a network receiver device, from a video streaming solution, segments for each of a plurality of video streams over one or more multicast channels. The network receiver device is configured to cache the segments for consumption by one or more client devices. The method also includes detecting a first network congestion condition is satisfied at the network receiver device. The method further includes, in response to detecting the first network congestion condition is satisfied, selecting a first one of the plurality of video streams having a lower priority, relative to a second one of the plurality of video streams. Additionally, the method includes requesting segments for the selected first video stream using an alternate channel and unsubscribing from the multicast channel for the selected first video stream.

Another embodiment described herein provides a client device that includes one or more computer processors and a memory containing computer program code that, when executed by operation of the one or more computer processors, performs an operation. The operation includes receiving, from a network receiver device, segments for each of a plurality of video streams. The network receiver device is subscribed to multicast communications for each of the plurality of video streams from a video streaming solution. The operation further includes determining, for each of the plurality of video streams, a respective measure of priority for the respective video stream for the client device. A first video stream of the plurality of video streams is being recorded on the client device and is determined to have a lower measure of priority. A second video stream of the plurality of video streams is being output for display on the client device and is determined to have a higher measure of priority, relative to the lower measure of priority for the first video stream. Additionally, the operation includes embedding data within one or more headers of one or more data packets specifying the measures of priority for each of the plurality of video streams. The operation also includes transmitting the one or more data packets containing the embedded data to the network receiver device.

Yet another embodiment described herein provides a network receiver device that includes one or more computer processors and a memory containing computer program code that, when executed by operation of the one or more computer processors, performs an operation. The operation includes subscribing to multicast data packets for each of a plurality of video streams from a video streaming solution. The operation also includes transmitting, to a client device, data packets for each of the plurality of video streams. Additionally, the operation includes receiving, from the client device, a respective indication of priority for each of the plurality of video streams. The operation further includes detecting a first network congestion condition has been satisfied. The operation includes, in response to detecting the first network congestion condition, selecting a first one of the plurality of video streams having a lower priority, relative to a second one of the plurality of video streams, based at least in part on the received indications of priority. Moreover, the operation includes unsubscribing to the multicast UDP data packets for the selected first video stream and retrieving data packets for the selected first video stream via an alternate channel.

### Example Embodiments

In many instances, content providers can provide multiple Adaptive Bitrate (ABR) profiles for a single broadcast channel. Generally speaking, multiple different ABR profiles (e.g., at varying bitrates) can be provided for each of a plurality of broadcast channels. Each profile can then be further split in time into segments (e.g., of duration of 2 or more seconds) for downloading using, for example, HTTP over unicast. Furthermore, client devices can be configured with logic to select one of the ABR profiles that is optimal for the given client device at segment boundaries. That is, it is generally preferable for a client device to display the highest quality video profile possible, and since network resources and processing capabilities can vary greatly between client devices, the optimal video profile can vary greatly between client devices. As an example, a very high bitrate encoding may be optimal for a dedicated streaming device on a high-speed network, while a relatively lower bitrate encoding may be optimal for a mobile device on a mobile network. As such, by providing multiple encodings at varying bitrates for each broadcast channel, content providers can better ensure that client devices can retrieve a stream that is close to optimal for the particular client device.

Many video clients are configured with logic to dynamically select between a plurality of video streaming profiles for a given instance of video content. For example, a content distribution network (CDN) could provide a plurality of different segmented video streaming profiles for the instance of video content, with each profile corresponding to a respective instance of the video content encoded in a respective bitrate. Generally, such video clients monitor the rate at which they receive segments of video data and to scale the video streaming profile accordingly. For example, upon determining that the segments are not being received fast enough, the client devices could select a lower bitrate profile to help prevent buffer underrun and pausing of the streaming video. As another example, when the client determines that the video data is being received sufficiently quickly, the client could request a higher bitrate profile to improve the quality of the video streaming experience.

Generally, multicast ABR solutions have a sender device that delivers segments for each available ABR profile (or a subset) from a source and transmits the segments for each profile to its own multicast IP destination, For example, each ABR profile can correspond to a respective bitrate encoding of video content, When requesting segments for a video profile, the requests from the client video players can be redirected to their local receiver device (e.g., a network gateway device for a home network, a set-top box, etc.). Generally, the client can specify the video profile being requested (e.g., using a unique identifier corresponding to the video profile). To supply video segments from the video profile, the receiver device can subscribe to the multicast stream containing segments from the specified ABR profile.

For example, a video client could request an ABR video from a media server, and the media server could transmit a manifest file to the video client. The video client could process the manifest file and determine which bitrates are available for the corresponding video. The video client could also determine which of the bitrates is appropriate for the corresponding client device. For example, a mobile client device could be configured to select the relatively low bitrate encoding, while a dedicated video streaming device on a high-speed network connection could be configured to select the relatively high bitrate encoding. In some embodiments, the video client may specify the requested encoding rate based on a specified URL. For example, to get a 3 Mb/s ABR segment, the video client may request “www.example.com/content/3000000/segment3.ts”, where the 3 Mb/s segment is identified based on the “3000000” in the URL.

When the upstream network becomes congested with traffic or otherwise experiences problems, the upstream network devices can become unable to supply requested video segments to downstream client devices in sufficient time for the playback of the video content and/or without suffering from data loss. Available multicast ABR solutions use error correction and retransmission to ensure the integrity of the multicast data under conditions where the bandwidth available exceeds that that is required. When the upstream bandwidth is constrained, however, multicast ABR receivers (e.g., a network gateway device for a home network) may eventually fall back to unicast data communications, e.g., Transmission Control Protocol (TCP). While such behavior may be optimal behavior in some circumstances, doing so in a situation where the upstream network bandwidth is constrained further exacerbates the problem by further restricting bandwidth, as now the network devices within the network are requested to transmit the unicast data packets in addition to the multicast data packets. While some network operators reserve sufficient multicast (e.g., User Datagram Protocol (UDP)) bandwidth for the services that it wishes to multicast to prevent this situation from occurring, such a solution is less dynamic in nature then unicast-based ABR streams and diminishes the advantages of adaptive bitrate video streaming in general.

Generally, when a video player on a client device downloads a segment faster than it takes to consume the video data contained within the segment, the video player can determine that the download of the segment (which is of known size) will complete sufficiently quickly by measuring the bitrate during the time the segment was being downloaded. As such, the video player will remain on the current ABR profile. When downloading a subsequent segment where the bitrate is lower, but still sufficient for the player to determine that the segment will be downloaded at a rate faster than consumption, the video player can choose to remain on the current ABR profile. At some point, where the video player determines that the download of a segment will exceed the time that it would take to consume the segment (risking a decoder under-run), the video player can take corrective action, abandoning the download of the segment at that bitrate and opting to download a lower bitrate version of the segment. While downloading the lower bitrate segment, the video player can again check whether the time required to download the segment at the then available bitrate is sufficient once again. The video player could continue to download lower bitrate segments, upon determining that such downloads will complete sufficiently quickly to be played back on schedule, but the downloads are not occurring quickly enough to warrant attempting to download the segments at a higher bitrate ABR profile. If the video player subsequently determines that there is sufficient speed to abandon the download of the lower bitrate segment and attempt to download the high bitrate segment, the video player can then request segments for the higher bitrate profile.

Generally, the adaptation logic in the video player can account for certain network conditions (e.g., local network conditions) but may not have sufficient logic and/or information to account for priorities between given video streams. In some cases, where the video player device can determine that the network bandwidth has become constrained, the network gateway device can abort the transmission of the current segment for one of the streams and can request a retransmission at a lower bitrate ABR profile. As the network bandwidth continues to be constrained, however, an under-run can occur, e.g., where the segment that the video player client wishes to download has not been fully received. In this case the network gateway device may have little choice but to satisfy the video player client's segment request from a fully unicast path. For example, the video player could be downloading two video streams, with one being saved for subsequent viewing and one being actively viewed by a user, and conventional solutions could select one of the video streams to revert to a fully unicast path. However, as conventional solutions may not have sufficient information to select the optimal video stream to delay, the user experience may be negatively affected.

For example, it may be preferable to treat the video stream being actively viewed by the user as higher priority, relative to the video stream being saved for subsequent viewing, as any delays or other problems with the actively viewed stream may be immediately perceptible to the user and can negatively affect the streaming experience. On the other hand, the video streaming being saved for subsequent viewing may not be viewed for a substantial period of time (if ever), and thus any transient interruptions to the saving of the video content may be resolved when those delays or other problems are resolved.

As such, embodiments described herein provide techniques for influencing the behavior of a video player client device. Embodiments could receive, at a network receiver device, from a video streaming solution, multicast User Datagram Protocol (UDP) data packets for each of a plurality of video streams. The multicast data packets could be transmitted across a first network during transmission from the video streaming solution to the client device, and the first network could be configured to prioritize UDP traffic over TCP traffic. In one embodiment, the client device comprises an endpoint device, such as a dedicated streaming set-top box or a tablet computing device. In a particular embodiment, the client device comprises a network gateway device for a network that is configured to cache video content for consumption by endpoint client devices on the network.

A video streaming management component on the client device could determine a first network congestion condition is satisfied at the client device. For example, the video streaming management component could determine that a threshold level of packet loss is reached for one of the video streams. In one embodiment, the video streaming management component is configured to classify each of the video streams being downloaded based on priority, and the video streaming management component could associate a respective network congestion condition with each priority. As an example, a video streaming being actively consumed on the client device could be determined to be high priority, while a video stream being cached on the client device for subsequent consumption could be classified as a lower priority stream. In such an example, the acceptable threshold of packet loss for the higher priority stream could be higher than the acceptable threshold of packet loss for the lower priority stream.

In response to detecting the congestion condition, the video streaming management component could select a first one of the plurality of video streams having a lower priority, relative to a second one of the plurality of video streams. In the aforementioned example, the video streaming management component could select the video stream being cached on the client device as the lower priority video stream, relative to the video stream being actively viewed on the client device. The video streaming management component could then request segments using unicast (e.g., TCP) for the selected first video stream, rather than the multicast (e.g., UDP) segments for the first video stream. In doing so, the video streaming management component could take advantage of the configuration of the network that prioritizes UDP traffic over TCP traffic, in order to apply a higher priority to the data packets of the higher priority video stream than the data packets of the lower priority video stream.

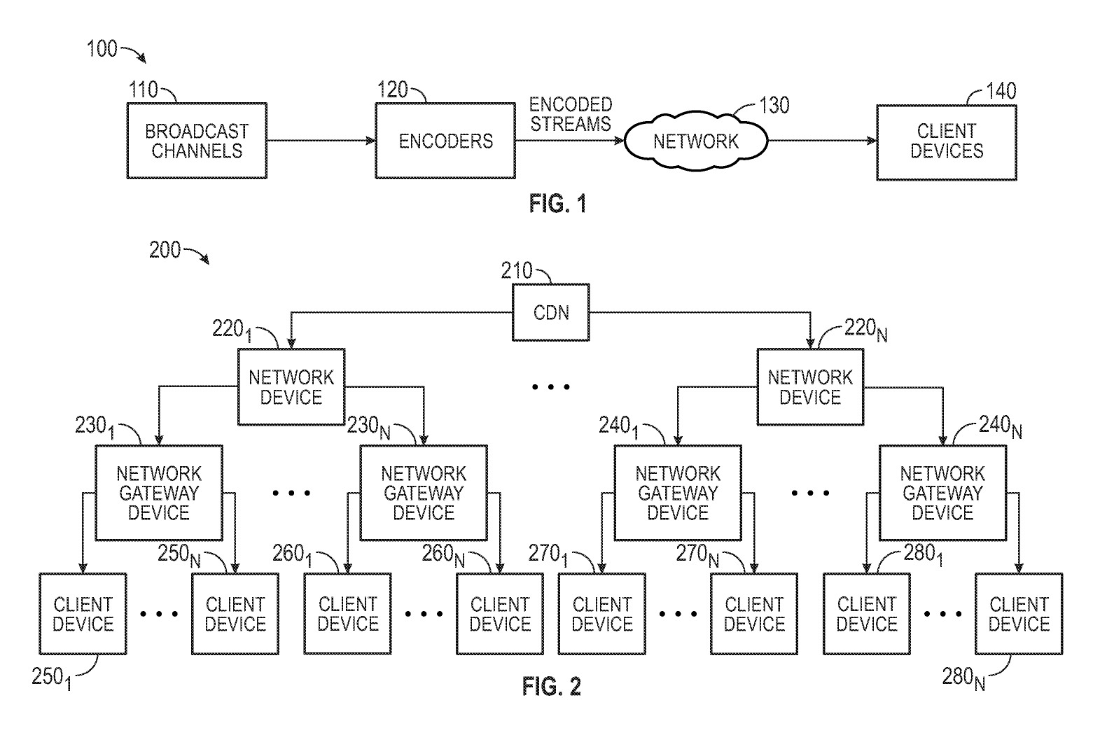

FIG. 1 illustrates a system for delivering encoded video streams to client devices, according to one embodiment described herein. As shown, the system 100 includes a plurality of broadcast channels 110, a plurality of encoders 120, a network 130 and a plurality of client devices 140. Generally, a master video stream is provided for each of the broadcast channels 110. Such a master video stream is typically a high-resolution video stream containing video content for the corresponding broadcast channel. The encoders 120 can then process the master video streams for the broadcast channels 110 to produce encoded ABR video profiles for a given stream. For example, three of the encoders 120 could be assigned to a particular one of the broadcast channels 110, and each of the three encoders could be configured to transcode the master video stream for the broadcast channel at a different bitrate. As an example, the three encoders could be configured to encode the master video stream for the broadcast channel at a relatively high bitrate, a relatively moderate bitrate and a relatively low bitrate.

The encoded streams could then be transmitted to the client devices 140 using the network 130. In doing so, the content provider could generate a manifest file specifying that the particular broadcast channel is available in the three different bitrates, and could transmit such a manifest file to the client devices 140 using the network 130. Each of the client devices 140 could be configured to process the manifest file and to determine which of the available profiles is optimal for the particular client device. For example, a mobile client device could be configured to select the relatively low bitrate profile, while a dedicated video streaming device on a high-speed network connection could be configured to select the relatively high bitrate profile. Depending on the performance of the streaming of the selected profile, the client devices could then dynamically adjust their selected profile. Continuing the above example, if the mobile client device determines that segments for the profile are arriving well in advance of their playback time, the mobile client device could request to begin receiving segments from the moderate bitrate encoding profile. As another example, if the dedicated streaming client device determines that segments are not arriving as quickly as expected and that buffer underrun is likely to occur, the dedicated streaming client device could request to begin receiving segments from the moderate bitrate encoding profile.

According to one embodiment described herein, a network device within the network 130 can be configured to manage streaming video profile selections of downstream client devices 140. For example, such a network device could be configured with a video streaming management component, that is configured to receive multicast network communications for a first video streaming profile of a plurality of video streaming profiles, for a video content item. Generally, each of the plurality of video streaming profiles can correspond to video content encoded in a distinct manner (e.g., at a distinct bitrate). Such a network device can be subscribed to multicast communications from an upstream network device within the network 130, for a video stream corresponding to the first video streaming profile. Such a subscription can be semi-permanent (e.g., each day when the system is operating properly, multicast data corresponding to the video stream will be transmitted to the network device), for example for broadcast channel implementations, or can be dynamic (e.g., responsive to an occurrence of a particular event).

Generally, the encoded video profiles generated by the encoders 120 can be transmitted to the client devices 140 using the network 130 in of different ways. One such way is through multicast communications, where encoded video profiles are transmitted to all subscribing network devices within the network. FIG. 2 illustrates a network topology for delivering encoded video profiles to client devices, according to one embodiment described herein. As shown, the network topology 200 includes a CDN 210, network devices 220_{1-N}, network gateway devices 230_{1-N} and 240_{1-N}, and client devices 250_{1-N}, 260_{1-N}, 270_{1-N}, and 280_{1-N}. In the depicted example, the network gateway devices 230_{1-N} and 240_{1-N} are configured to also serve as a router for a home network. For purposes of the present example, assume that the network gateway device 240₁ represents a client set-top box configured to act as a router for the client device 270_{1-N}.

In the depicted example, if the client device 270₁ requests a particular encoded video stream for a particular broadcast channel, the client set-top box 240₁ can be configured to subscribe to multicast transmissions from the network device 220_{N} for the particular encoded video profile. In turn, the network device 220N can subscribe to multicast transmissions from the CDN 210 for the particular encoded video profile. One advantage to such an embodiment is that the segments for the particular encoded video profile can more easily be delivered to additional devices within the network topology 200. For example, if the client device 270_{N} also requests the particular encoded video profile for the particular broadcast channel, the client set-top box 240₁ can simply provide the client device 270_{N} with the segments for the particular encoded video profile already being received due to the client device 270₁'s request. In other words, the particular encoded video profile can be provided to the client device 270_{N} without creating an additional network connection with the CDN 210, thereby reducing the workload on the CDN 210, the network device 220_{N} and the client set-top box 240₁.m

In some instances, the network gateway devices 230_{1-N} and 240_{1-N} are configured to subscribe to multicast transmissions for at least one video profile for each of the broadcast channels 110. In turn, the network devices 220_{1-N} can subscribe to multicast transmissions for the at least one video profile for each of the broadcast channels 110. While such an embodiment creates a constant flow of network traffic between the CDN 210 and the network devices 220_{1-N}, and between the network devices 220_{1-N} and the network gateway devices 230_{1-N} and 240_{1-N}, it enables any of the client devices 250_{1-N}, 260_{1-N}, 270_{1-N}, and 280_{1-N} to retrieve segments for the requested video profiles from the corresponding client set-top box, using a local (and typically much faster) network connection. Moreover, regardless of the number of client devices 250_{1-N}, 260_{1-N}, 270_{1-N}, and 280_{1-N}, the workload on the CDN 210 remains constant, unlike conventional solutions where each of the client devices is configured to establish a separate network connection with the CDN 210 for streaming video content. As such, by transmitting the video profiles through multicast transmission techniques, embodiments provide a more scalable video streaming solution relative to conventional techniques.

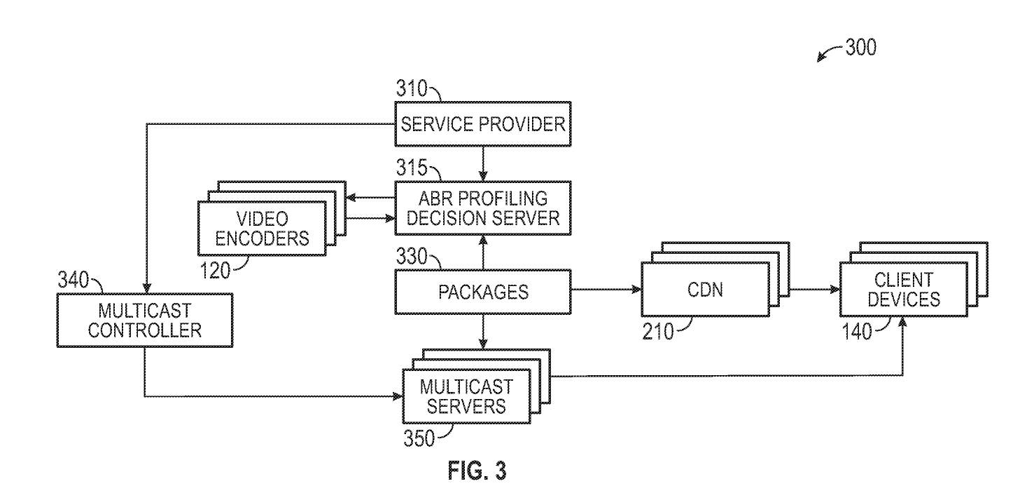

FIG. 3 illustrates a network topology for delivering encoded video profiles to client devices, according to one embodiment described herein. As shown, the system 300 includes a service provide 310, an ABR profile decision server 315, a plurality of video encoders 120, packagers 330, CDNs 210, client devices 140, a multicast controller 340 and multicast servers 350.

The video encoders 120 can then encode the master streams for their assigned broadcast channel to produce the ABR streams at their respective assigned bitrate. The encoded streams can then be processed by the packagers 330, which can provide the encoded ABR content to the CDN 210 and the multicast servers 350 for delivery to the client devices 140. Additionally, the packagers 330 can provide client consumption information back to the ABR profile decision server 315, for use in refining the allocation of the video encoders 120 to the broadcast channels. In the depicted embodiment, the CDNs 210 can be configured to deliver the encoded ABR streams to particular client devices 140 using unicast transmissions, while the multicast servers 350 can be configured to deliver the encoded ABR streams to other client devices 140 using multicast transmissions. The client devices 140 can be configured to report back client consumption information to the ABR profile decision server 315. Such consumption information can include, for example, which broadcast channels are selected, which ABR profiles are selected, and so on. The ABR profile decision server 315 could then use such information to refine the allocation of video encoders 120 to the broadcast channels.

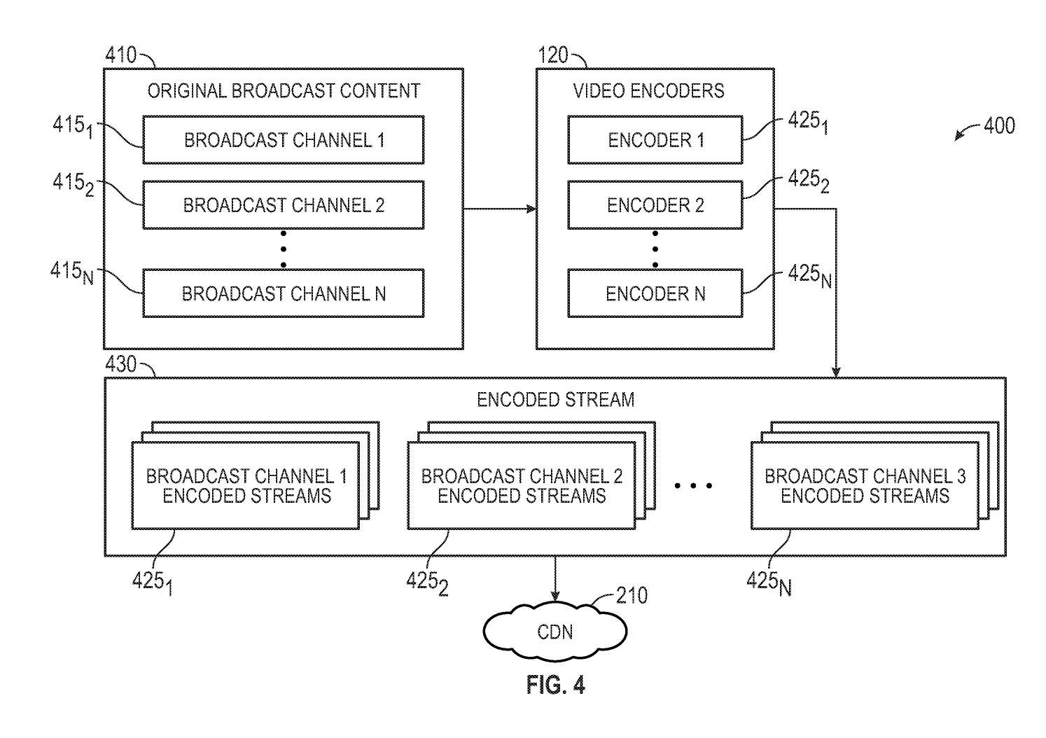

FIG. 4 illustrates a workflow for providing encoded ABR video content for a plurality of broadcast channels, according to one embodiment described herein. As shown, the workflow 400 illustrates original broadcast content 410 (also referred to herein as master streams for broadcast channels), video encoders 120, encoded streams 430 and CDN 210. Generally, the ABR profile decision server 315 can determine an optimal encoding of the video encoders 120, such that no less than a minimum threshold and no more of a maximum threshold of the encoders 415_{1-N} is assigned to each of the broadcast channels 415_{1-N}. The encoded ABR video streams 430 produced by the encoders 415_{1-N}, depicted as the broadcast channel encoded streams 425_{1-N}, can then be provided to CDN 210 for distribution to client devices. As discussed above, the CDN 210 can be configured to provide the encoded streams 430 to the client devices using various techniques (e.g., unicast communications, multicast communications, etc.). In a particular embodiment, the CDN 210 is configured to transmit requested profiles to the client devices using unicast communications, and the encoded streams 430 can also be provided to a multicast server (not shown) for transmission to client devices using multicast communications.

As discussed above, multicast ABR segments from a single stream may be used by a client for more than one application. For example, segments may be recorded for later consumption or viewed live at the time of transmission. Where delivery bandwidth is limited, the consumption for these different applications may be subject to different prioritization. However, any given multicast of a video service may be used for one application by some clients and a different application by others. While conventional solutions may suggest a static assigned Quality of Service (QoS) in the network and generate a multicast for each application so that IP prioritization can be used at the network layer to prefer one application over the other, such solutions may not be appropriate for every client device. For example, a particular video stream may be more popular in the aggregate across all client devices, but the particular video stream may be a low priority network flow for a given client device that is storing (and/or caching) the video data from the network flow for later consumption. Likewise, a video stream of relatively low popularity in the aggregate could be a high priority stream for a given home network, as users of the given home network may be actively viewing the video stream.

One embodiment provides a system in which multicast data for multiple video streams is consumed by a client device, but the client device is configured to manage priority between the video streams depending on the client's intended use of the video streams. For example, the client device could assign priority so as to prefer to interrupt recordings that are not being viewed (e.g., video content being cached for later consumption). In such an example, data for the lower priority streams could be retrieved using unicast (e.g., TCP) at best effort rates whilst protecting the live viewing sessions over multicast so the viewer's immediate experience is not interrupted. It should be noted in this example that recording may not be adaptive and that only a single representation may be acquired. Additionally, falling back to best effort unicast may imply that the recording runs at non-realtime and thus falls behind the higher priority streams being viewed live. However, not recording streams in realtime will still typically not vary the quality that the user will see when they ultimately attempt to play that content from disk, as in many instances the user will be viewing the recorded content at a substantially later point in time. Moreover, given sufficient network capacity, the unicast flows may complete faster than realtime and get the client back to live which in turn would allow it to return to the multicast.

Embodiments described herein could use the NACK-oriented reliable multicast (NORM) protocol and could allow the client to use a lower threshold of packet loss to trigger a switch from UDP to TCP transmission in the lower priority service. In this way, as bandwidth is restricted, a client with the lower threshold to losses will drop a multicast and ultimately switch to unicast reception before the one with a higher threshold. Doing so creates an implicit prioritization of the higher threshold multicast over the lower without having two multicasts with different network QoS.

In one embodiment, the client device applies a static prioritization model based on the importance of receiving live data to the applications it is running. In an alternate embodiment, the prioritization could be driven by the entire E2E system to guide the application prioritization according to pressure (and perhaps cost) on the delivery network. For example, if 1000 users are viewing a live channel but 1000000 users are recording a different channel, it may be more cost effective for the operator to move the live viewing sessions to unicast and maintain the recordings. As such, the error threshold used in the client device could be updated at any time during the acquisition of content by logic on the content server and the client itself may have a separate communication channel back to the distribution headend to be informed of ongoing priorities.

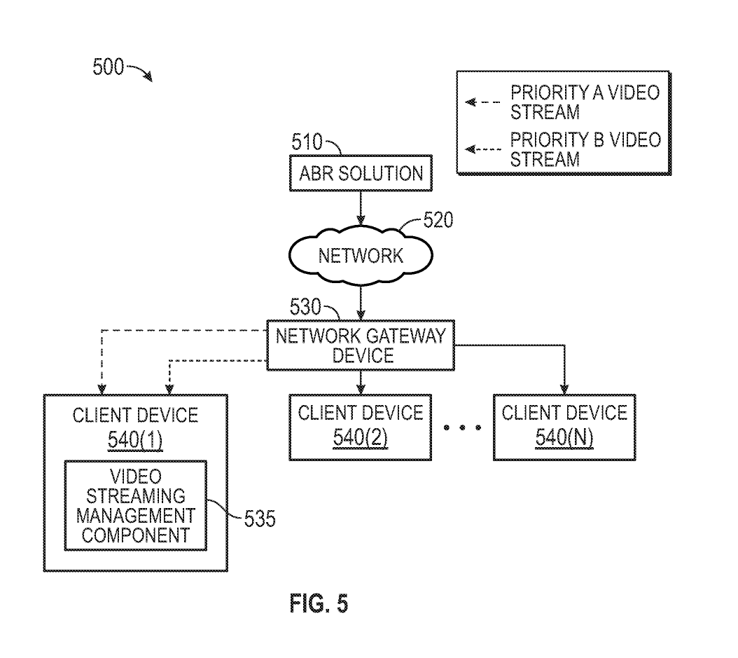

FIG. 5 illustrates a network environment configured with a video streaming management component, according to one embodiment described herein. As shown, the network 500 includes an ABR solution 510, a network 520, a network gateway device 530 and client devices 540(1)-(N). The client device 540(1) is configured with a video streaming management component 535. According to one embodiment, the client device 540(1) could receive segments via a multicast channel (e.g., UDP) for each of a plurality of video streams from the ABR solution 510. In the depicted embodiment, the client device 540(1) is receiving segments for two video streams, a priority A video stream and a priority B video stream. The multicast segments could be transmitted across the network 520 during transmission from the video streaming solution to the client device, and the network 520 could be configured to prioritize UDP traffic over TCP traffic.

The video streaming management component 535 could determine a first network congestion condition has been satisfied at the client device 540(1). For example, the video streaming management component 535 could be configured to monitor one or more congestion conditions defined by one or more congestion condition definitions, each specifying one or more metrics (e.g., packet loss, latency, buffer underrun, etc.) to monitor and a threshold value(s) corresponding to the one or more metrics. For example, the video streaming management component 535 could monitor the amount of packet loss for one of the plurality of video streams and could determine when a threshold amount of packet loss has been reached.

In response to the congestion condition being satisfied, the video streaming management component 535 on the client device 540(1) could select a first one of the plurality of video streams having a lower priority, relative to a second one of the plurality of video streams and the video streaming management component 535 could request segments for the selected first video stream over a unicast channel, rather than over a multicast channel. For example, the video streaming management component 535 could determine that the priority A video stream is a lower priority video stream, relative to the priority B video stream. In one embodiment, the video streaming management component 535 selects one or more high priority video streams based on which stream(s) are being actively viewed at the client device 540(1). Doing so will cause the network 520 to prioritize the transmission of the data packets for the higher priority video stream over the data packets for the lower priority video stream, as the network 520 is configured to prioritize the transmission of UDP data packets over the transmission of TCP data packets.

Generally, the video streaming management component 535 can be configured to use any suitable technique for determining the prioritization between the video streams. For example, the video streaming management component 535 could be configured to access one or more predefined rules defining prioritization between active video streams on the client device 540(1). As an example, a rule could specify that a stream being actively viewed is given top priority, a stream for a channel or program commonly watched on the client device 540(1) is given medium priority, and a stream for a channel or program rarely watched on the client device 540(1) is given low priority. Continuing the example, assume three streams are being downloaded to the client device 540(1) when a congestion condition occurs, with one of the streams being actively viewed on the client device 540(1), another stream corresponding to a program commonly watched on the client device 540(1) and a third stream corresponding to a program that has rarely been watched on the client device 540(1).

To alleviate the congestion condition, the video streaming management component 535 could determine that the third stream is the lowest priority of the three streams, based on the prioritization laid out in the predefined rules. The video streaming management component 535 could then unsubscribe from multicast communications for the third stream and could begin requesting segments from a unicast channel for the third stream. If the video streaming management component 535 subsequently determines that the congestion condition is still satisfied even after the third stream has switched to the unicast channel, the video streaming management component 535 could select the second stream (i.e., in this example, the stream being recorded and corresponding to the commonly viewed program) and could transition to unicast communications for the second stream (e.g., by unsubscribing to multicast communications for the second stream and requesting segments for the stream via a unicast channel). At a subsequent point in time, upon determining that sufficient network throughput is again available for the client device 540(1), the video streaming management component 535 could transition the second and/or third stream back to multicast communications.

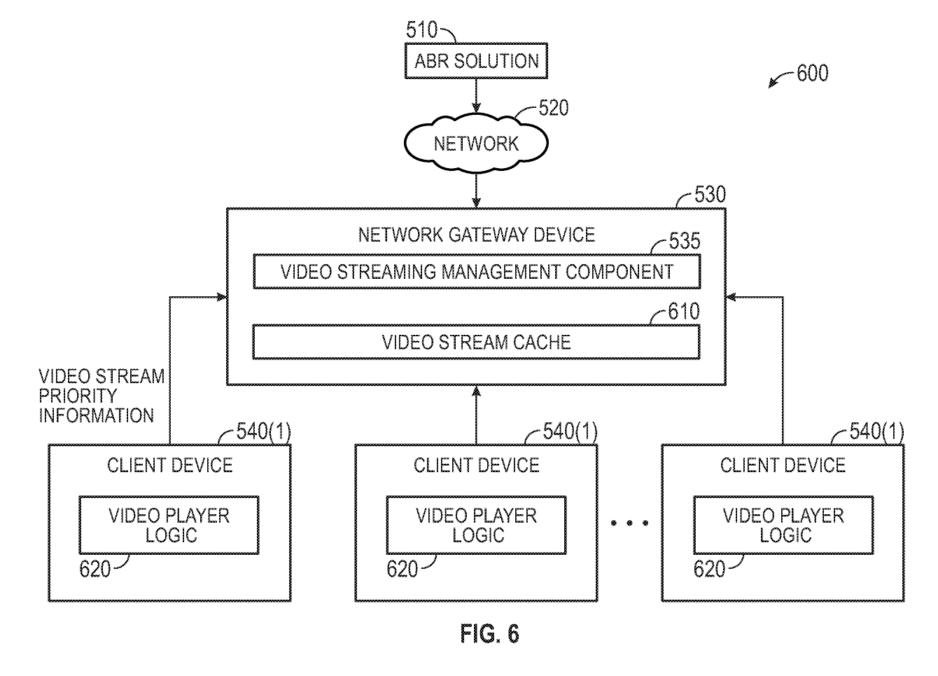

FIG. 6 illustrates a network environment that includes a network receiver device configured with a video streaming management component, according to one embodiment described herein. As shown, the environment 600 includes an ABR solution 510, a network 520, a network gateway device 530 and client devices 540(1)-(N). Each client device 540(1)-(N) is configured with video player logic 620(1)-(N).

In the depicted embodiment, the network gateway device is configured to function as a network receiver device, in that the network gateway device can subscribe to multicast data communications for a plurality of video streams and store the received segments in the video stream cache 610. For example, the video player logic 620(1) on the client device 540(1) could request segments for each of a plurality of video streams from the network gateway device 530. In response, the video streaming management component 535 on the network gateway device 530 could subscribe to multicast data communications for each of the plurality of video streams, and upon receiving the multicast segments for the video streams, the video streaming management component 535 could store the segments in the video stream cache 610. The video streaming management component 535 could then provide the segments from the cache to the video player logic 620(1) on the client device 540(1) for consumption.

In one embodiment, the video player logic 620 is configured to determine an indication of priority for each of a plurality of video streams for the respective client device 540. For example, the video player logic 620 could request segments for two video streams, a priority A video stream and a priority B video stream. In one embodiment, the video player logic 620 could determine the priority of the video streams based on how the segments for the video streams are being consumed on the client device. For example, the video player logic 620 could determine that a video stream that is being watched live has a high priority, while a video stream that is being recorded for later viewing has a relatively low priority. More generally, however, any algorithm for determining priority between the various video streams can be used, consistent with the functionality described herein.

The video player logic 620(1) on the client device 540(1) could then transmit the determined measures of priority to the video streaming management component 535 on the network gateway device 530. For example, the video player logic 620 could embed the indications of priority in a header (e.g., an HTTP header) within data (e.g., data packets) transmitted to the video streaming management component 535. The video streaming management component 535 could then use the indications of priority to determine how to respond to a network congestion condition being satisfied. For example, upon determining a network congestion condition is satisfied, the video streaming management component 535 could unsubscribe from UDP traffic for a lowest priority ABR stream. The video streaming management component 535 could then request segments for the lowest priority ABR stream via an alternate channel. In an embodiment where the network 520 is configured to prioritize UDP traffic over TCP traffic, the video streaming management component 535 could then request segments via a TCP channel for the lowest priority ABR stream. The video streaming management component 535 could then determine whether the congestion condition is still satisfied and, if so, could again select a lowest priority video stream and again unsubscribe from multicast communications for the selected stream. The process could be repeated until the congestion condition is alleviated.

In one embodiment, the video streaming management component 535 is configured to receive indications of priority for various video streams from each of the client device 540(1)-(N). Additionally, the video streaming management component 535 can receive indications of priority of the video streams from a remote server (e.g., a server relating to the ABR solution 510). The video streaming management component 535 can be configured to perform an arbitration process to determine an overall priority for each of the plurality of video streams. In doing so, the video streaming management component 535 can consider all of the received indications of priority for each of the video streams. For example, the client device 540(1) may specify that a particular video stream is a high priority stream, while a client device 540(2) may specify that the same video stream is a medium priority stream. The video streaming management component 535 can reconcile the various indications of priority for each of the plurality of video streams, to determine an overall indications of priority for each stream.

In one embodiment, the video streaming management component 535 can apply a respective weight to the indications of priority received from each of the client devices 540(1)-(N) (as well as the remote server). For example, where the client device 540(1) represents a primary television device within a home environment, the video streaming management component 535 could be configured to weight the indications of priority received for the client device 540(1) higher than the other client devices 540(2)-(N). Upon determining the overall indications of priority for the video streams, the video streaming management component 535 can then select a lowest overall priority video stream to unsubscribe from multicast communications for, when a congestion condition is reached.

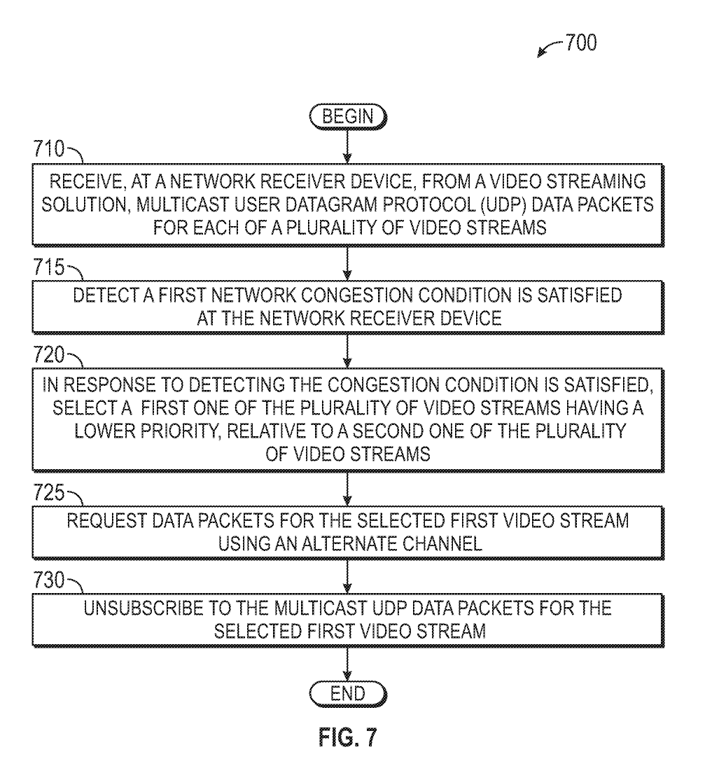

FIG. 7 is a flow diagram illustrating a method for managing retrieval of video streams, according to one embodiment described herein. As shown, the method 700 begins at block 710, where the video streaming management component 535 receives, at a network receiver device, from a video streaming solution, segments over a multicast channel for each of a plurality of video streams. The network receiver device may be configured to cache the segments for consumption by one or more client devices.

The video streaming management component 535 detects a first network congestion condition is satisfied at the network receiver device (block 715). In response to detecting the congestion condition is satisfied, the video streaming management component 535 selects a first one of the plurality of video streams having a lower priority, relative to a second one of the plurality of video streams. The video streaming management component 535 then requests segments for the selected first video stream using an alternate channel (block 720). Additionally, the video streaming management component 535 unsubscribes to the multicast channel for the selected first video stream (block 725), and the method 700 ends.

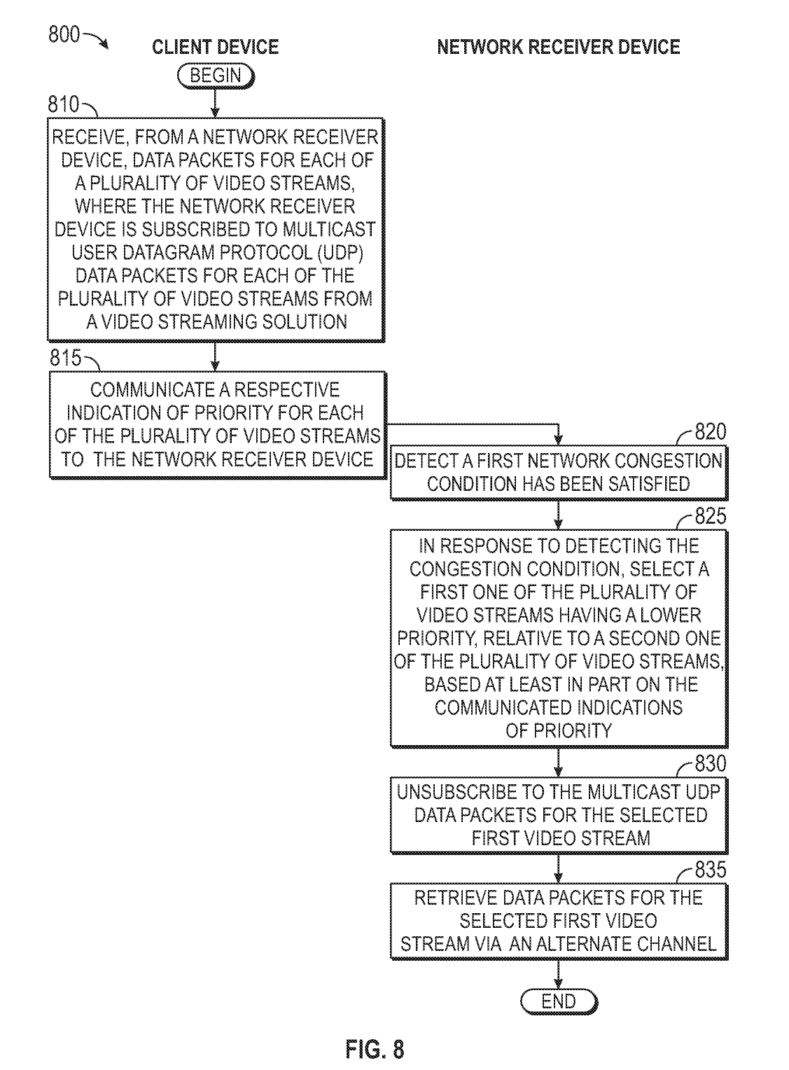

FIG. 8 illustrates a method of managing ABR streams based on client-specified indications of priority, according to one embodiment described herein. As shown, the method 800 begins at block 810, where a client device receives, from a network receiver device, segments for each of a plurality of video streams. The network receiver device in the depicted example is subscribed to multicast traffic for each of the plurality of video streams from a video streaming solution. The client device communicates a respective indication of priority for each of the plurality of video streams to the network receiver device (block 815). For example, the client device could embed priority information for each of the plurality of video streams within an HTTP header of data packets transmitted to the network receiver device.

The video streaming management component 535 on the network receiver device then detects a first network congestion condition has been satisfied (block 820). In response to detecting the congestion condition, the video streaming management component 535 selects a first one of the plurality of video streams having a lower priority, relative to a second one of the plurality of video streams, based at least in part on the communicated indications of priority (block 825). The video streaming management component 535 unsubscribes to the multicast traffic for the selected first video stream (block 830). Additionally, the video streaming management component 535 retrieves segments for the selected first video stream via an alternate channel (block 835), and the method 800 ends.

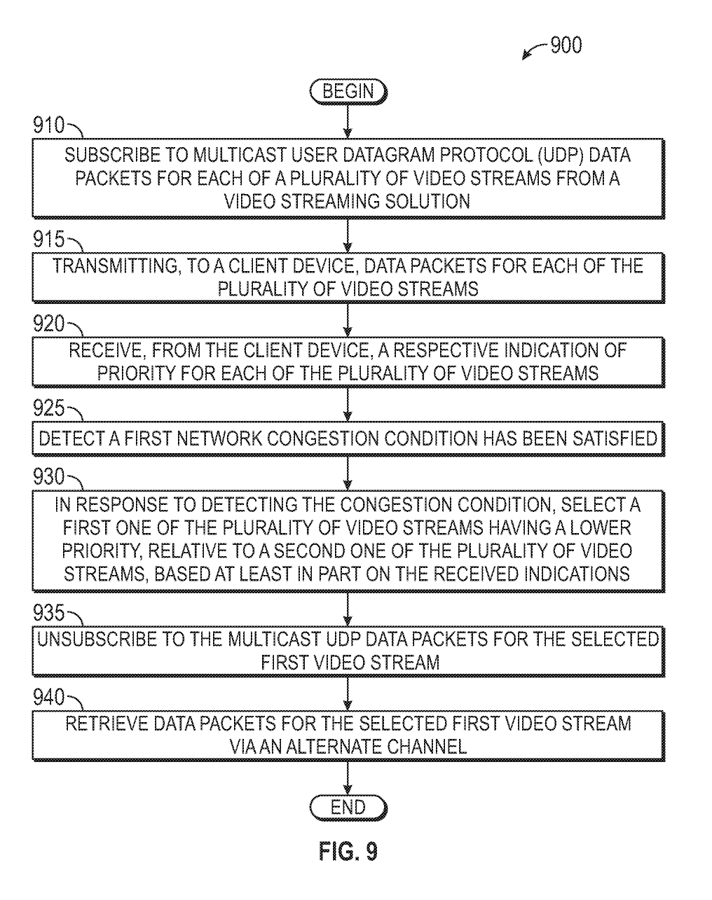

FIG. 9 is a flow diagram illustrating a method of managing ABR streams at a network receiver device, according to one embodiment described herein. As shown, the method 900 begins at block 910, where the video streaming management component 535 on the network receiver device subscribes to multicast traffic for each of a plurality of video streams from a video streaming solution. For example, the video streaming management component 535 could receive requests from one or more client devices specifying the plurality of video streams and, in response, could subscribe to the multicast data communications for the requested video streams.

Upon subscribing to the multicast data communications, the video streaming management component 535 can receive and cache segments for the plurality of video streams. Likewise, the video streaming management component 535 can transmits, to a client device, segments for each of the plurality of video streams from the cache (block 915). Additionally, the video streaming management component 535 receives, from the client device, a respective indication of priority for each of the plurality of video streams (block 920). For example, the client device could embed the priority information with an HTTP header of data packets transmitted from the client device to the video streaming management component 535 on the network receiver device, and the video streaming management component 535 could extract the priority information from the data packets to determine the indication of priority for each of the plurality of video streams.

In the depicted example, the video streaming management component 535 detects a first network congestion condition has been satisfied (block 925). For example, the video streaming management component 535 could determine that the congestion condition is satisfied when a threshold level of error has been reached for one of the plurality of video streams. As another example, the video streaming management component 535 could determine that the congestion condition is satisfied when segments are being received for a particular one of the plurality of video streams, at a rate that will eventually lead to buffer underrun. More generally, the video streaming management component 535 can be configured with any conditional logic to determine when a congestion condition has been reached, consistent with the functionality described herein.

In response to detecting the congestion condition, the video streaming management component 535 selects a first one of the plurality of video streams having a lower priority, relative to a second one of the plurality of video streams, based at least in part on the received indications of priority (block 930). The video streaming management component 535 then unsubscribes to the multicast communications for the selected first video stream (block 935), and retrieves segments for the selected first video stream via an alternate channel (block 940), and the method 900 ends. For example, the video streaming management component 535 could request segments for the selected first video stream over a unicast channel (e.g., TCP). As another example, the video streaming management component 535 could delay the retrieval of the segments for a predefined period of time, and once the predefined period of time has elapsed, the video streaming management component 535 could determine whether the congestion condition is still satisfied. If so, the video streaming management component 535 could again delay the retrieval of the segments for some period of time. If the congestion condition has been alleviated, the video streaming management component 535 could again subscribe to multicast communications for the selected first video stream.

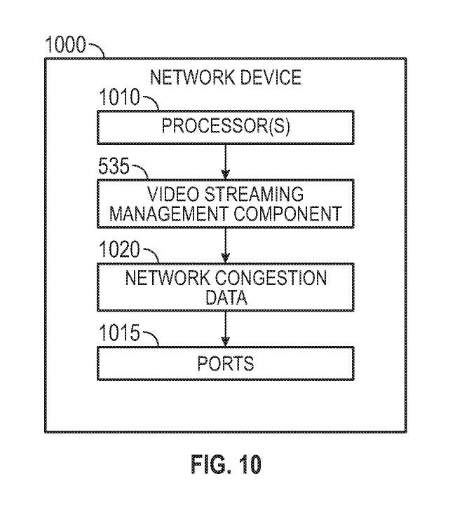

FIG. 10 illustrates a network device configured with video streaming management logic, according to one embodiment described herein. As shown, the network device 1000 includes, without limitation, processors 1010, video streaming management logic (also referred to herein as video streaming management component 535), network congestion data 1020 and communication ports 1015. The processor 1010 may be any processing element capable of performing the functions described herein. The processor 1010 represents a single processor, multiple processors, a processor with multiple cores, and combinations thereof. The network congestion data 1020 may contained with a memory device (not shown), which may be either volatile or non-volatile memory and may include RAM, flash, cache, disk drives, and the like. The network device may also include a control plane for configuring and managing the forwarding logic.

Generally, the network congestion data 1020 represents data collected by the video streaming management component 535 that describes a network state of the network device 1000. For example, the network congestion data 1020 could specify a retransmission request rate of one of more downstream clients of the network device 1000. The video streaming management component 535 could receive multicast network communications for a first video streaming profile, of a plurality of video streaming profiles, for a video content item. For instance, the network device 100 could be subscribed to multicast communications from an upstream network device, for a video stream corresponding to the first video streaming profile. As an example, the video streaming management component 535 could subscribe to the multicast communications for the video stream, responsive to a request for the first video streaming profile from a downstream client device.

In one embodiment, the network device 1000 represents a client device (e.g., a dedicated set-top streaming box, a tablet device, a mobile device, etc.). The video streaming management component 535 could receive, from a video streaming solution, segments for each of a plurality of video streams over a multicast channel. Such multicast traffic could be transmitted across a first network during transmission from the video streaming solution, and the first network could be preconfigured to prioritize UDP traffic over TCP traffic.

The video streaming management component 535 could determine when a first network congestion condition has been satisfied at the client device. For example, the first network congestion condition could be a rate of packet loss for one of the plurality of video streams. In response to the first network congestion condition being satisfied, the video streaming management component 535 could select a first one of the plurality of video streams having a lower priority, relative to a second one of the plurality of video streams, and could request segments over a TCP channel for the selected first video stream, rather than multicast. In one embodiment, the first video stream represents a stream being recorded on the client device when the first network congestion condition is determined to be satisfied at the client device, and wherein the second video stream represents a stream being viewed at the client device when the first network congestion condition is determined to be satisfied at the client device. In this way, the video streaming management component 535 can prioritize video streams that, if delayed, would affect the user's viewing experience. On the other hand, a greater amount of packet loss and/or delay may be acceptable for a stream being recorded for later viewing, as the lost packets can be downloaded at a subsequent point in time but before the stream is viewed by a user.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, at a network receiver device, from a video streaming solution, segments for each of a plurality of video streams over one or more multicast channels, wherein the network receiver device is configured to cache the segments for consumption by one or more client devices;
detecting a first network congestion condition is satisfied at the network receiver device;
in response to detecting the first network congestion condition is satisfied, selecting a first one of the plurality of video streams having a lower priority, relative to a second one of the plurality of video streams, yielding a selected first video stream;
requesting segments for the selected first video stream using an alternate channel; and
unsubscribing from a first multicast channel of the one or more multicast channels for the selected first video stream.

2. The method of claim 1, wherein the segments for each of the plurality of video streams are received across a first network during transmission from the video streaming solution to the network receiver device, and wherein the first network is configured to prioritize multicast traffic over unicast traffic.

3. The method of claim 2, wherein requesting segments for the selected first video stream using the alternate channel further comprises requesting segments for the selected first video stream from the video streaming solution over a unicast channel.

4. The method of claim 1, further comprising:
upon determining that sufficient network throughput is available, subscribing to the first multicast channel for the first video stream at the network receiver device.

5. The method of claim 1, wherein the first video stream is being recorded on a first one of the one or more client devices when the first network congestion condition is satisfied, and wherein the second video stream is being viewed at a second one of the one or more client devices when the first network congestion condition is satisfied.

6. A client device, comprising:
one or more computer processors; and
a memory containing computer program code that, when executed by operation of the one or more computer processors, performs an operation comprising:
receiving, from a network receiver device, segments for each of a plurality of video streams, wherein the network receiver device is subscribed to multicast communications for each of the plurality of video streams from a video streaming solution;
determining, for each of the plurality of video streams, a respective measure of priority for the respective video stream for the client device, wherein a first video stream of the plurality of video streams is being recorded on the client device and is determined to have a lower measure of priority, and wherein a second video stream of the plurality of video streams is being output for display on the client device and is determined to have a higher measure of priority, relative to the lower measure of priority for the first video stream;
embedding data within one or more headers of one or more data packets specifying the measures of priority for each of the plurality of video streams; and
transmitting the one or more data packets containing the embedded data to the network receiver device.

7. The client device of claim 6, wherein the embedded data within the one or more headers further comprises a threshold level of error for the respective video stream.

8. The client device of claim 6, wherein the network receiver device is configured to unsubscribe from multicast communications for the respective video stream upon determining the threshold level of error is reached, and wherein the network receiver device is configured to retrieve segments for the selected first video stream via an alternate channel by requesting segments for the selected first video stream over a unicast channel.

9. The client device of claim 6, wherein the segments are transmitted across a first network during transmission from the video streaming solution to the network receiver device.

10. The client device of claim 9, wherein the first network is configured to prioritize multicast traffic over unicast traffic.

11. A network receiver device, comprising:
one or more computer processors; and
a memory containing computer program code that, when executed by operation of the one or more computer processors, performs an operation comprising:
subscribing to multicast data packets for each of a plurality of video streams from a video streaming solution;
transmitting, to a client device, data packets for each of the plurality of video streams;
receiving, from the client device, a respective indication of priority for each of the plurality of video streams;
detecting a first network congestion condition has been satisfied;
in response to detecting the first network congestion condition is satisfied, selecting a first one of the plurality of video streams having a lower priority, relative to a second one of the plurality of video streams, based at least in part on the received indications of priority, yielding a first selected video stream;
unsubscribing from the multicast data packets for the selected first video stream; and
retrieving data packets for the selected first video stream via an alternate channel.

12. The network receiver device of claim 11, wherein the operation further comprises:
caching, in memory on the network receiver device, multicast data packets for the plurality of video streams,
wherein the data packets that are transmitted to the client device are retrieved from the cache in the memory of the network receiver device.

13. The network receiver device of claim 11, wherein the indications of priority for the plurality of video streams each comprises a respective measure of acceptable error for a respective one of the plurality of video streams, and wherein the first network congestion condition is satisfied when the measure of acceptable error corresponding to the first video stream is reached on the network receiver device.

14. The network receiver device of claim 11, wherein determining that the first network congestion condition is satisfied further comprises determining that a measure of error for one of the plurality of video streams reaches a predefined threshold level of error.

15. The network receiver device of claim 11, wherein retrieving data packets for the selected first video stream via the alternate channel further comprises requesting segments for the selected first video stream via a TCP unicast channel.

16. The network receiver device of claim 11, wherein the multicast data packets are transmitted across a first network during transmission from the video streaming solution to the network receiver device, wherein the first network is configured to prioritize multicast traffic over unicast traffic, and wherein requesting data packets for the selected first video stream using the alternate channel further comprises requesting segments for the first video stream from the video streaming solution via a unicast channel.

17. The network receiver device of claim 16, the operation further comprising:
upon determining that sufficient network throughput is available, subscribing to multicast data communications for the first video stream.

18. The network receiver device of claim 11, wherein the multicast data packets further comprise User Datagram Protocol (UDP) data packets.

19. The network receiver device of claim 11, the operation further comprising:
receiving, from a second client device, a respective indication of priority for each of the plurality of video streams;
determining an overall indication of priority for each of the plurality of video streams, based on the indications of priority for each of the plurality of video streams received from the client device and the second client device,
wherein selecting the first video stream is further based on the first video stream having a lower overall indication of priority, relative to the overall indication of priority for the second video stream.

20. The network receiver device of claim 19, wherein the multicast data packets are transmitted across a first network during transmission from the video streaming solution to the network receiver device, and wherein the first network is configured to prioritize multicast traffic over unicast traffic, and the operation further comprising:
receiving, from a remote system, a respective indication of network priority for each of the plurality of video streams, wherein the indications of network priority reflect the priority of each video stream within the first network.
